(19) United States
(12) Patent Application Publication
(10) Pub. No.: US 2012/0151242 A1
(43) Pub. Date: Jun. 14, 2012

(54) APPARATUS FOR OPTIMIZING SUPPLY POWER OF A COMPUTER COMPONENT AND METHODS THEREFOR

(75) Inventors: Timothy P. McGrath, Vista, CA (US); Robert Roark, Temecula, CA (US); Franz Michael Schuette, Colorado Springs, CO (US)

(73) Assignee: OCZ TECHNOLOGY GROUP, INC., San Jose, CA (US)

(21) Appl. No.: 13/159,557

(22) Filed: Jun. 14, 2011

Related U.S. Application Data
(63) Continuation-in-part of application No. 11/938,343, filed on Nov. 12, 2007, now Pat. No. 7,983,860.
(60) Provisional application No. 60/865,182, filed on Nov. 10, 2006.

(51) Int. Cl. G06F 1/28

(52) U.S. Cl. 713/340

(57) ABSTRACT

A system and method for monitoring power consumption of a computer system component, such as a central processing unit (CPU), of a desktop computer system. The component is supplied with supply power from a power supply unit of the computer through a power supply cable. A coupling is disposed between the power supply unit and a substrate (e.g., motherboard) on which the component is mounted, and is electrically connected to at least one power supply line of the power supply cable and a power supply connector on the substrate. The power supply line carries a supply voltage. The current flow through the power supply line is determined, a power consumption reading for the component is generated based on the supply voltage and the current flow through the power supply line, and the supply voltage on the power supply line is modulated to determine a lowest current flow therethrough.

This application is a continuation-in-part patent application of U.S. patent application Ser. No. 11/938,343, filed Nov. 12, 2007, which claims the benefit of U.S. Provisional Application No. 60/865,182, filed Nov. 10, 2006. The contents of these prior patent documents are incorporated herein by reference.

### BACKGROUND OF THE INVENTION

The present invention generally relates to computers. More particularly, this invention relates to methods and systems for monitoring power consumption of computer components, such as a central processing unit (CPU) of a desktop computer.

Central processing units (CPUs) have evolved over the last decades from relatively simple RISC or x86 processors with a single execution unit to hyperscalar processing units featuring several instances of separate arithmetic logic units and floating point units, decoders and schedulers. In addition, almost all current midrange to high-end processors feature several layers of integrated cache memory comprised mostly of on-die SRAMs. Recent developments have further placed the memory controller onto the processor die. The microprocessor industry has also seen the emergence of multicore processors, that is, the combination of several complete processors into a single package for advanced parallel processing of multiple threads.

It is understood that such evolution of microprocessors incurs costs with regard to the number of transistors per processor. The Intel® “Kentsfield” quad core features no less than 582 million transistors. Moreover, clock speeds of microprocessors have increased about 50× over the past decade. Increased transistor count along with increased clock speed translates into increased thermal dissipation as well. Therefore, a substantial amount of effort and research has gone into power and thermal management of CPUs. Some measures have involved software-based throttling on the level of the operation system, and others are embedded within the Basic Input/Output System (BIOS).

A prerequisite for successful power management is the understanding of where and under what circumstances most of the power is being consumed. This understanding, however, cannot be achieved without acquisition and analysis of power consumption-related data. On the system level, this can be done through power meters interposed between the wall outlet and the computer's power supply unit. However, this method does not take into account the different loads on the individual system components and can only generate a summary report. On the other hand, for targeted, specific monitoring of the power consumption of, for example, the CPU, this method is not suitable because all other system components, including the power supply's efficacy, mask the real power consumption of the CPU itself.

Currently, power monitoring is predominantly done on the system level through devices like Seasonic's Power Angel or Extech 380308 Power Analyzer. In mobile applications (e.g., notebooks, laptops, PDAs, etc.), power consumption is sometimes monitored using specific software to interface with current sensors. On the desktop level, so far, no easy way exists to monitor specifically the isolated power consumption of the CPU as a function of load.

In view of the above, it would be desirable if it were possible to monitor specifically the isolated power consumption of a desktop CPU (or like motherboard device) as a function of load. Exactly this kind of monitoring is pivotal for an optimal configuration of the computer hardware as well as the optimal load balancing between several computers for the purpose of the most energy-efficient operation of all computer systems. This is true especially in server and workstation environments. In addition, even for a single user, monitoring of the CPU power consumption may give some valuable information about background processes that are using an excess of power.

### BRIEF DESCRIPTION OF THE INVENTION

The present invention provides a system and method suitable for monitoring power consumption of a central processing unit (CPU) or other power-consuming component of a desktop computer system.

According to a first aspect of the invention, a computer system component mounted on a substrate is supplied with supply power from a power supply unit of the computer through a power supply cable, and the system includes a coupling that is disposed between the power supply unit and the substrate and is electrically connected to at least one power supply line of the power supply cable and a power supply connector on the substrate. The at least one power supply line carries a supply voltage, and one or more devices associated with the coupling determine current flow through the at least one power supply line and provides a power consumption reading for the component based on the supply voltage and the current flow through the at least one power supply line.

According to a second aspect of the invention, the method entails supplying a computer system component mounted on a substrate with supply power from a power supply unit of the computer through a power supply cable, and placing a coupling between the power supply unit and the substrate so that the coupling is electrically connected to at least one power supply line of the power supply cable and a power supply connector on the substrate. With the at least one power supply line carrying a supply voltage, current flow through the at least one power supply line is determined, and a power consumption reading for the component is generated based on the supply voltage and the current flow through the at least one power supply line. In the case of a modular power supply unit with removably attached cables, the coupling can also be an integral part of the cable and use the temperature-dependent resistance of a wire within the cable as a resistor.

According to certain preferred aspects of the invention, multiple power supply lines are consolidated within the coupling into a single conductor, through which current flow is determined. A resistor can be combined with the conductor, across which a voltage differential is measured to determine current flow through the power supply lines. Alternatively, the coupling may include a Hall effect transducer adapted to sense current flow through the power supply line(s).

According to other aspects of the invention, the power supply unit modulates its output voltages to match conditions corresponding to energy efficient voltage conversion at the component as determined as current flow through the coupling. A voltage drop across the coupling can further indicate an over-current condition and trigger shut-down of the power supply unit. In modular power supply units with removable cable harness, independent modulation of the output voltages for more than one DC outlet can be used to accurately match the dynamic requirements of multiple components.

In view of the above, it can be seen that a significant advantage of this invention is that it provides a system and method for monitoring the isolated power consumption of a CPU, as well as other computer system components. The system and method enable one to optimize the hardware configuration of a computer, as well as optimize load balancing between several computers for the purpose of energy-efficient operation of several computer systems in, for example, a server or workstation environment. Moreover, the invention allows for modulating the output voltage of the power supply unit to better match the harmonics of the supply voltage to system components and thereby provide a basis for a more energy-efficient conversion.

Other aspects and advantages of this invention will be better appreciated from the following detailed description.

### BRIEF DESCRIPTION OF THE DRAWINGS

FIG. 1 is a schematic view of a metering system for monitoring power consumption of a central processing unit on a computer motherboard, in which a coupling is interposed between a power supply cable to the motherboard and an auxiliary power connector on the motherboard in accordance with a first embodiment of this invention.

FIG. 2 is a schematic view of a metering system for monitoring power consumption of a central processing unit, in which a Hall effect transducer is used in accordance with a second embodiment of this invention.

FIG. 3 is a flow diagram representing a process by which a power supply unit voltage is modulating until a targeted low current flow is found, at which point the voltage locks in until a load change occurs or an overcurrent situation occurs to trigger an immediate shutdown of the power supply unit or one of its outputs.

### DETAILED DESCRIPTION OF THE EMBODIMENT

The present invention takes advantage of the fact that increased power consumption of recent CPUs has resulted in CPUs being provided with power through power supply lines that are separate from the remainder of the computer system power. Generally, before the emergence of the Intel® Pentium® 4, CPU power was usually derived from either the 3.3V or the 5V rail supplied through AT or ATX power connectors. The increased power demand of the Pentium® 4 led to the use of dedicated supply lines at higher voltages, typically dedicated 12V auxiliary power supply lines, to power the CPU. Currently most CPU and motherboard designs use processor power circuitry electrically isolated from the rest of the motherboard's power and ground planes.

According to the present invention, the separation of the CPU supply power from other power and ground planes on the motherboard permits the use of the present invention, which entails monitoring the CPU's power consumption by measuring current flow through dedicated power supply lines (typically 12V) to the CPU. It should be noted that CPUs typically receive a constant voltage supply level appropriate for the particular CPU from a voltage regulator module (VRM) on the motherboard. Though the efficacy of a given VRM is not precisely defined, VRM efficacy is generally believed to be on the order of about 70 to 80%, which is sufficiently precise for purposes of implementing the present invention.

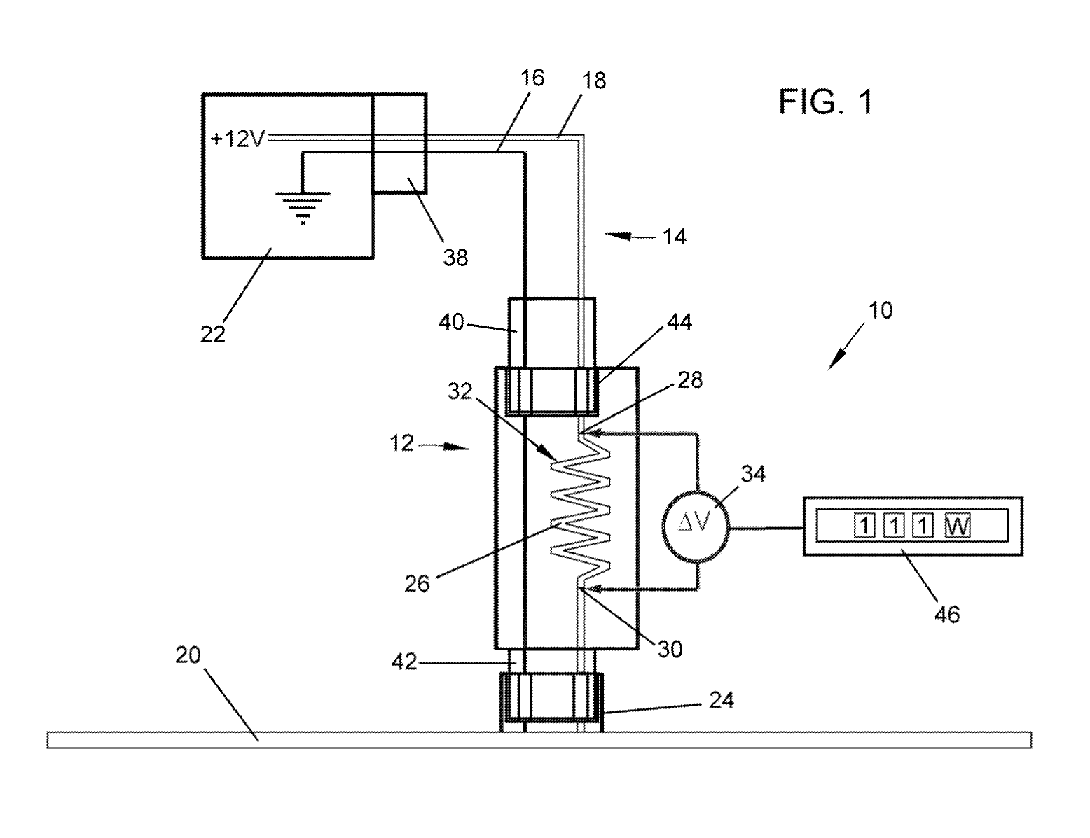

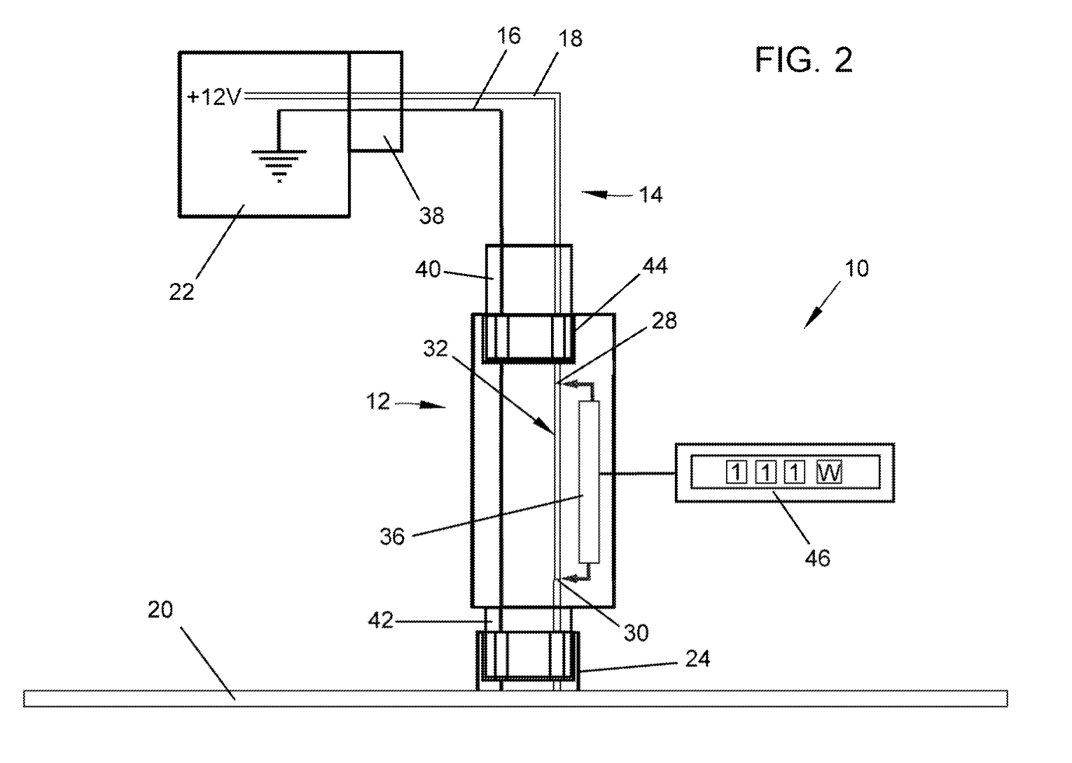

FIGS. 1 and 2 schematically represent two embodiments of the invention encompassing a metering system 10 that makes use of a coupling 12 installed on a dedicated power supply cable 14 to a CPU (not shown) or other device of interest on a computer motherboard 20 or a peripheral device receiving dedicated power. The power supply cable 14 is typically designated the auxiliary power supply cable of the computer's power supply unit (PSU) 22, and carries one or more ground lines 16 and one or more power supply lines 18, typically at least some of which provide supply voltages of 12V. The motherboard 20 is conventionally equipped with an auxiliary power supply connector 24 (for example, a 20-pin ATX or 24-pin EPS connector), from which power from the power supply lines 18 is typically routed to the VRM (not shown) and then the CPU on the motherboard 20. The different embodiments of FIGS. 1 and 2 will be described in more detail below, with consistent reference numbers used to identify the same or equivalent components where appropriate.

With knowledge of the supply voltage delivered by the supply lines 18 to the CPU, the invention monitors current flow through the supply lines 18 in order to compute CPU power consumption. A first and readily uncomplicated approach is schematically represented in FIG. 1, which represents the coupling 12 as containing a resistor 26 placed in electrical series with the power supply lines 18. For this purpose, the incoming supply lines 18 are consolidated to form a single conductor 32, a portion having a precisely defined resistance so as to constitute a resistor 26. The measured voltage drop across the resistor 26 can be converted into current flow according to Ohm's law. As shown, the coupling 12 can be configured as a separate add-on unit with a plug 42 that plugs directly into the auxiliary power supply connector 24 on the motherboard 20, and a connector 44 into which the auxiliary power plug 40 of the cable 14 is plugged. Alternatively, the coupling 12 can be integrated into the auxiliary power plug 40 of the cable 14, in which case the coupling 12 is effectively a component of the PSU 22.

The resistor 26 is preferably a relatively low Ohm resistor, for example, about 0.01 to 0.05 Ohm, so as to minimize the voltage drop in the supply power to the CPU. Based on Ohm's law, V=IR, it can be understood that a 5 Amp current flowing through the power supply lines 18 would result in a measurable 0.05V drop across the resistor 26, which is easily tolerated by the CPU VRM yet can still be accurately be sensed. The 50 mV differential can be measured across two test points 28 and 30 located at or adjacent opposite ends of the resistor 26 and sensed by a voltmeter 34 (such as an analog-digital (AD) converter) or other suitable voltage sensor associated with the coupling 12. With knowledge of the supply voltage on the power supply lines 18, the differential across the test points 28 and 30 can be monitored and used to reliably calculate the total power going to the CPU based on the equation, P=IV, in which I is the calculated current through the resistor 26, V is the supply voltage, and P is the power consumption in Watts. As noted above, the CPU power consumption can be more accurately calculated by further factoring in the efficacy of the VRM. The voltmeter 34 or other suitable processing unit can be adapted to convert and display the power consumption of the CPU. For example, the voltmeter 34 can be connected to a digital display 46 configured to be installed in a drive bay, or implemented in any other manner suitable for a desktop computer. Alternatively, the display 46 could incorporate circuitry to also perform the measuring and conversion functions of the voltmeter 34.

In the second embodiment of FIG. 2, the resistor 26 and voltmeter 34 are replaced with a Hall effect transducer 36 placed adjacent to the conductor 32. The Hall effect transducer 36 connects to test points 28 and 30 at opposite ends of the conductor 32 within the coupling 12. In accordance with known Hall effect principles, the transducer 36 generates a voltage in response to the magnetic field produced by the conductor 32 that varies with current, and therefore does not affect current flow or produce a voltage drop through the conductor 32. Hall effect current transducers are commercially available from a wide variety of sources, with a common output signal being about 1 mV per 1 A of sensed current. If low currents flow through the power supply lines 18, the relatively low sensitivity typically associated with the Hall effect transducers can be addressed at least in part by looping the conductor 32 several times through the transducer 36, in which case the number of loops will directly multiply the voltage output of the transducer 36. In any event, current flow through the conductor 32 can be determined based on the output of the transducer 36, and with knowledge of the supply voltage on the power supply lines 18, the total power going to the CPU can be reliably calculated in the same manner described above for the first embodiment. The power consumption of the CPU can then be displayed on a suitable display 46.

In a third embodiment, the power supply lines 18 are in the form of one or more modular cables, that is, cables that are plugged into a DC outlet at the PSU 2s. Moreover, the cables themselves are calibrated and have a known resistance, including a temperature coefficient that can be used to calculate the current passing through, based on the case temperature and the voltage drop. In other words, the temperature-dependent internal resistances of the cables are used instead of a dedicated interposed resistor.

In order to counteract voltage drops on the supply lines 18 that may occur at high loads, FIG. 1 shows the PSU 22 as being equipped with a load compensation device 38 to maintain a constant voltage output at the auxiliary connector 24.

Most load compensation devices known in the art work through a feedback loop, that is, the output voltage is monitored through a feedback pin by the power supply. Typical solutions employ a TL431 programmable shunt regulator in conjunction with an optoelectric coupler or optocoupler to provide feedback loop isolation. This allows for accurate control of either the voltage or the ripple supplied to the targeted device (for example, a CPU) or the connector connecting to the targeted device. In this context, it is further interesting to note that especially in the case of multi-phase voltage regulators, slight variations in the input power can have substantial impact on the energy-efficiency of the entire system. Especially when down-regulation of voltage (from relatively high voltage to a lower voltage) is involved, better efficiency is achieved if the target voltage is a harmonic of the source voltage. For example, going from 12V to 1V on a 12-phase voltage regulator module is more efficient than going to, for example 0.98V or 1.05V. However, efficiency can be boosted if the input voltage would trail the output voltage, in this case it would drop to 11.76V or increase to 12.6V. The net effect in this case is less current draw and less heat generation, meaning that the system runs more energy efficient and cooler. A side effect in this case is the reduction of ripple current, meaning that the output power is cleaner.

The aspects described above are of particular importance given the dynamic adjustment of supply voltages of modern computer components based on load. For example, under idle conditions, typical Intel® or AMD® processors move to the lowest performance state (P-state), which means they will go to the lowest supported frequency and the lowest supported supply voltage at around 0.95V. As soon as there is load on the processor, it will go to a higher P-state, meaning that the processor signals to the voltage regulator module (VRM) that it needs higher supply voltage before ramping up its core frequency. Typical load supply voltages are around 1.3 to 1.4V. In light of the above, modulation of the output voltage of the power supply, that is, the voltage going into the VRM, may have a pronounced effect on the efficiency of the VRM itself and also reduce noise in the supply voltage to the processor.

Without knowing the actual output voltages, especially in a computer system with several independently acting components, it is nearly impossible to predict the most efficient input voltage for the highest system power efficiency based on known target voltages. Moreover, it is not even necessary to know the target voltage since a power supply with enough intelligence to adjust the input voltage while monitoring the actual power consumption will be able to identify the highest system power efficiency based on the lowest power draw regardless of the behavior of the individual components. Accordingly, the load compensation device could use a microprocessor functionally connected to the TL431 shunt connector to perform output voltage modulation—within the tolerances of the specifications of the device (such as, for example the ATX specifications of ±5%)—and lock the voltage when, depending on the desired mode of operation, the minimum power consumption or the smallest ripple is measured.

Such scans can be performed either periodically or every time a change in load occurs. Current PSUs sample feedback voltage at about 1000 Hz, meaning that a complete scan can be done with reasonable accuracy in about 50 msec. In order to avoid over-nervous transients, hysteresis or inertia is designed in.

In most cases the system will spend most of the time close to idle which is typically the range of the lowest efficiency. Among other reasons, this is a consequence of most efforts being spent on optimizing efficiency at high load. The minimum and maximum power efficiency could then also be displayed, or else, the energy savings at any load compared to either a static input voltage or an average based on the scanned range of input voltages.

As energy efficiency of electronics is becoming increasingly more important, it is foreseeable that microprocessors will be used in future designs to accurately control the voltages generated by a PSU not only on a per voltage rail basis, but rather for each supply cable to match the specific load characteristics and requirements of a targeted device (for example, a CPU). Accordingly, a power supply could have a “core” voltage that is then adjusted at the output node to the system for each cable.

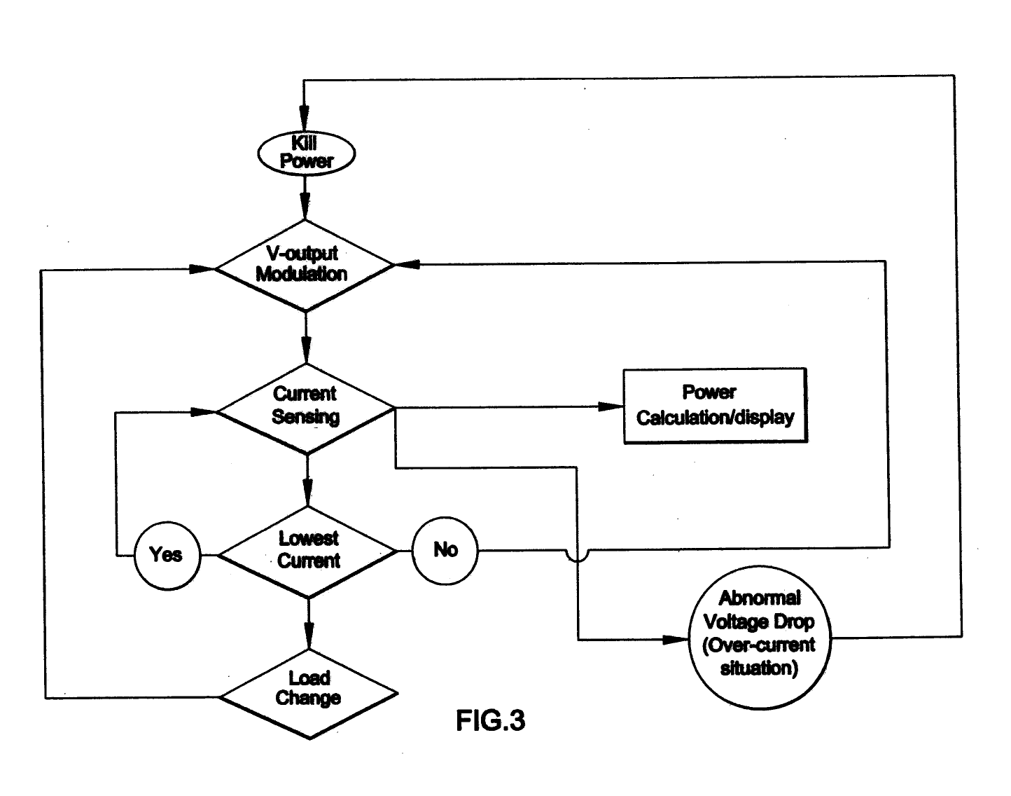

According to Ohm's law, power (in Watts) is the product of current and voltage. This allows for the monitoring of over-current or-over power situations, in that the voltage will drop if the current increases beyond a specified or tolerated maximum. If the voltage drops below a certain level, then this can be used to trigger shut-down of the PSU in order to protect the system. In contrast to the current state of the art, this aspect of the invention allows for the implementation of overcurrent protection on a per-device level, since it is the direct supply to the device that is monitored via the cable. These and other additional aspects of the invention are represented in FIG. 3, which is a flow diagram representing the modulation of a PSU voltage until the lowest current flow is found, at which point the voltage locks in until a load change occurs or a overcurrent situation occurs on a power supply line to trigger an immediate shutdown of the PSU. Alternatively, an over-current condition on a power supply line can be used to selectively disconnect power to the power supply line and generate an error message without shutting down the PSU.

From the above, the present invention can be seen to provide several advantages, most notably, the ability to accurately isolate and monitor CPU power consumption with hardware that is both inexpensive and uncomplicated to implement. Moreover, by monitoring the power consumption as a function of voltage modulation on different rails, it is possible to adjust the voltages generated by a PSU to optimally match the most efficient input voltage range for the processor VRM under any load conditions. In addition, an extra level of device protection is implemented by avoiding over-current situation on the level of the supply cable. It should be noted that essentially the same equipment and method described above can be used to monitor the power consumption of other computer system components with dedicated supply power, including but not limited to graphics processors (GPUs) and graphics cards featuring on-board memory and a graphics processor. Particularly in the case of graphics adapters with power requirements of up to 400 W in the latest implementations power optimization and over-current protection is of paramount importance. As such, the invention is not limited to monitoring the power consumption of a CPU on a motherboard, but can be applied to a variety of other components that may be mounted to any suitable circuit board or substrate equipped with appropriate connections to a power supply of a computer.

In view of the above, while the invention has been described in terms of specific embodiments, it is apparent that other forms could be adopted by one skilled in the art. Furthermore, the functions of certain components could be performed by components of different construction but capable of a similar (though not necessarily equivalent) function. Therefore, the scope of the invention is to be limited only by the following claims.

1. A system for optimizing power consumption of a computer system component on a substrate of a computer, the computer system component being supplied with supply power from a power supply unit of the computer through at least one power supply cable, the system comprising:
a coupling disposed between the power supply unit and the substrate, the coupling being electrically connected to at least one power supply line of the power supply cable and a power supply connector on the substrate, the at least one power supply line carrying a supply voltage;
means associated with the coupling for determining current flow through the at least one power supply line;
means for generating a power consumption reading for the component based on the supply voltage and the current flow through the at least one power supply line;
means for providing the power consumption reading of the component as feedback to, the power supply unit; and
means for modulating the supply voltage of the power supply cable to optimize energy efficiency of the power supplied through the power supply cable.

2. The system according to claim 1, wherein the coupling comprises a plug received in the power supply connector of the substrate.

3. The system according to claim 1, wherein the at least one power supply line comprises a plurality of power supply lines within the power supply cable, and the plurality of power supply lines are consolidated to form a conductor within the coupling.

4. The system according to claim 3, wherein the determining means comprises a resistor within the coupling and in series with the conductor.

5. The system according to claim 4, wherein the resistor has oppositely-disposed end points, and the determining means comprises means for measuring a voltage drop across the end points.

6. The system according to claim 3, wherein the determining means comprises a Hall effect transducer within the coupling and adapted to sense current flowing through the conductor.

7. The system according to claim 1, wherein the coupling comprises a power supply cable that is detachable from the power supply unit, the power supply cable having a plug adapted to plug into the power supply connector on the substrate.

8. The system according to claim 1, wherein the system comprises more than one power supply cable and the modulating means independently modules the supply voltages of each of the power supply cables.

9. The system according to claim 8, the system further comprising means for shutting down the power supply unit in the event that a voltage drop occurs on any one of the power supply cables.

10. A method of optimizing power consumption of a computer system component on a substrate of a computer, the computer system component being supplied with supply power from a power supply unit of the computer through a power supply cable, the method comprising:
placing a coupling between the power supply unit and the substrate so that the coupling is electrically connected to at least one power supply line of the power supply cable and a power supply connector on the substrate, the at least one power supply line carrying a supply voltage;
determining current flow through the at least one power supply line;
generating a power consumption reading for the component based on the supply voltage and the current flow through the at least one power supply line; and
modulating the supply voltage on the at least one power supply line of the power supply cable to determine a lowest current flow therethrough.

11. The method according to claim 10, wherein, if a load change occurs on the at least one power supply line, a permissible range of voltages is scanned to determine a lowest current flow.

12. The method according to claim 11, wherein the supply voltages of at least two power supply lines are independently modulated and a lowest current flow is determined for each of the power supply lines.

13. The method according to claim 10, further comprising using a voltage drop on the at least one power supply line to determine an over-current condition and to trigger shut-down of the power supply unit.

14. The method according to claim 10, further comprising using an over-current condition on the at least one power supply line to selectively disconnect power to the at least one power supply line and generate an error message without shutting down the power supply unit.

15. The method according to claim 10, wherein the determining step is performed using an internal resistance of the at least one power supply line using ambient temperature of the at least one power supply line and temperature compensation.

16. The method according to claim 10, further comprising calculating and displaying a delta between a highest and a lowest current draw within a scanned voltage window.

17. The method according to claim 10, wherein the displaying step comprises installing a display means in a drive bay of the computer.
